(19) United States
(12) Patent Application Publication
(10) Pub. No.: US 2024/0078500 A1
(43) Pub. Date: Mar. 7, 2024

(54) MANAGEMENT DEVICE AND MANAGEMENT METHOD

(71) Applicant: TOYOTA JIDOSHA KABUSHIKI KAISHA, Toyota-shi (JP)

(72) Inventors: Atsushi KOMADA, Nagakute-shi (JP); Mitsuru OGASAWARA, Gamagori-shi (JP); Masahiko ISHII, Okazaki-shi (JP); Hidetaka ASANO, Nissin-shi (JP); Tomokazu ISHII, Okazaki-shi (JP); Koji HETSUGI, Toyota-shi (JP); Kosuke YONEKAWA, Nisshin-shi (JP); Yoshikazu JIKUHARA, Miyoshi-shi (JP)

(73) Assignee: TOYOTA JIDOSHA KABUSHIKI KAISHA, Toyota-shi (JP)

(21) Appl. No.: 18/448,384

(22) Filed: Aug. 11, 2023

(30) Foreign Application Priority Data
Sep. 7, 2022 (JP) 2022-142300

(51) Int. Cl. G06Q 10/083

(52) U.S. Cl. CPC G06Q 10/083

(57) ABSTRACT

A management device includes a communication device and a control device. The communication device is configured to communicate with a moving object configured to transport a product from an upstream company to a downstream company. The control device is configured to calculate CO2 emissions emitted by transportation of the product based on an amount of energy consumed by the moving object from a transportation start time point to a transportation completion time point of the product.

### CROSS-REFERENCE TO RELATED APPLICATION

This application claims priority to Japanese Patent Application No. 2022-142300 filed on Sep. 7, 2022, incorporated herein by reference in its entirety.

### BACKGROUND

### 1. Technical Field

The present disclosure relates to a management device and a management method.

### 2. Description of Related Art

With growing awareness of environmental issues, there is growing interest in carbon dioxide (CO2) emissions from production of products distributed on the market. There may be a case where a downstream company in a supply chain to which a product is delivered requests an upstream company for disclosure of the CO2 emissions from production of the product. The upstream company calculates the CO2 emissions emitted by the production of the product and discloses the calculated CO2 emissions to the downstream company.

For example, Japanese Unexamined Patent Application Publication No. 2016-126372 (JP 2016-126372 A) discloses a method for calculating CO2 emissions in a transportation process of products (including materials and components). The method for calculating the CO2 emissions in the transportation process disclosed in JP 2016-126372 A is a method for calculating the CO2 emissions corresponding to the purchase amount of goods based on a predetermined coefficient table, the industry to which the company belongs, and the purchase amount of the goods.

### SUMMARY

The method for calculating the CO2 emissions in the transportation process disclosed in JP 2016-126372 A estimates the CO2 emissions based on the predetermined coefficient table, and does not actually measure the emissions. Therefore, there is a possibility that a discrepancy may occur between the calculated CO2 emissions and the actual CO2 emissions required for transportation from the upstream company to the downstream company. A method for calculating the CO2 emissions in the transportation process more accurately is desired.

The present disclosure provides a management device and a management method for accurately calculating CO2 emissions in a transportation process.

A management device according to a first aspect of the present disclosure includes a communication device and a control device. The communication device is configured to communicate with a moving object configured to transport a product from an upstream company to a downstream company. The control device is configured to calculate CO2 emissions emitted by transportation of the product based on an amount of energy consumed by the moving object from a transportation start time point to a transportation completion time point of the product.

According to the above configuration, the CO2 emissions emitted by transportation of the product is calculated based on the amount of energy consumed by the moving object from the transportation start time point to the transportation completion time point of the product. Since the CO2 emissions are calculated based on the amount of energy that is actually used, it is possible to accurately calculate the CO2 emissions in the transportation process.

In the management device according to the first aspect of the present disclosure, the control device may be configured to acquire location information and a state information from the moving object via the communication device. The transportation start time point may be a time point at which the moving object is switched from a sleep state to an active state in a site of the upstream company. The transportation completion time point may be a time point at which the moving object is switched from the active state to the sleep state in a site of the downstream company.

According to the above configuration, it is possible to appropriately determine the transportation start time point and the transportation completion time point. Therefore, it is possible to accurately calculate the CO2 emissions in the transportation process.

In the management device according to the first aspect of the present disclosure, the moving object may include an internal combustion engine. The control device may be configured to calculate the CO2 emissions based on fuel consumption consumed by the moving object from the transportation start time point to the transportation completion time point.

According to the above configuration, the CO2 emissions can be calculated based on the fuel consumption consumed by the moving object from the transportation start time point to the transportation completion time point, that is, the amount of energy that is actually consumed. Therefore, it is possible to accurately calculate the CO2 emissions in the transportation process.

In the management device according to the first aspect of the present disclosure, the moving object may include a battery and a drive device configured to be driven using power of the battery. The control device may be configured to calculate the CO2 emissions based on power consumption consumed by the moving object from the transportation start time point to the transportation completion time point.

According to the above configuration, the CO2 emissions can be calculated based on the power consumption consumed by the moving object from the transportation start time point to the transportation completion time point, that is, the amount of energy that is actually consumed. Therefore, it is possible to accurately calculate the CO2 emissions in the transportation process.

A management method according to a second aspect of the present disclosure is executed by a management device. The management method includes communicating with a moving object configured to transport a product from an upstream company to a downstream company, and calculating CO2 emissions emitted by transportation of the product based on an amount of energy consumed by the moving object from a transportation start time point to a transportation completion time point of the product.

According to the present disclosure, it is possible to accurately calculate the CO2 emissions in the transportation process.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is an overall configuration diagram of a management system according to an embodiment;

FIG. 2 is a diagram showing an example of a packing box;

FIG. 3 is a functional block diagram of a control device of a management device of a company A, a control device of a management device of a company B, and a control device of a management device of a company C;

FIG. 4 is a flowchart showing the procedure of processing for reporting CO2 emissions Q2total in a transportation process, the processing being executed by the control device of the management device; and

FIG. 5 is a diagram showing an example of a packing box according to a first modification.

### DETAILED DESCRIPTION OF EMBODIMENTS

Hereinafter, an embodiment of the present disclosure will be described in detail with reference to the drawings. In the drawings, the same or corresponding portions are denoted by the same reference signs and the description thereof will not be repeated.

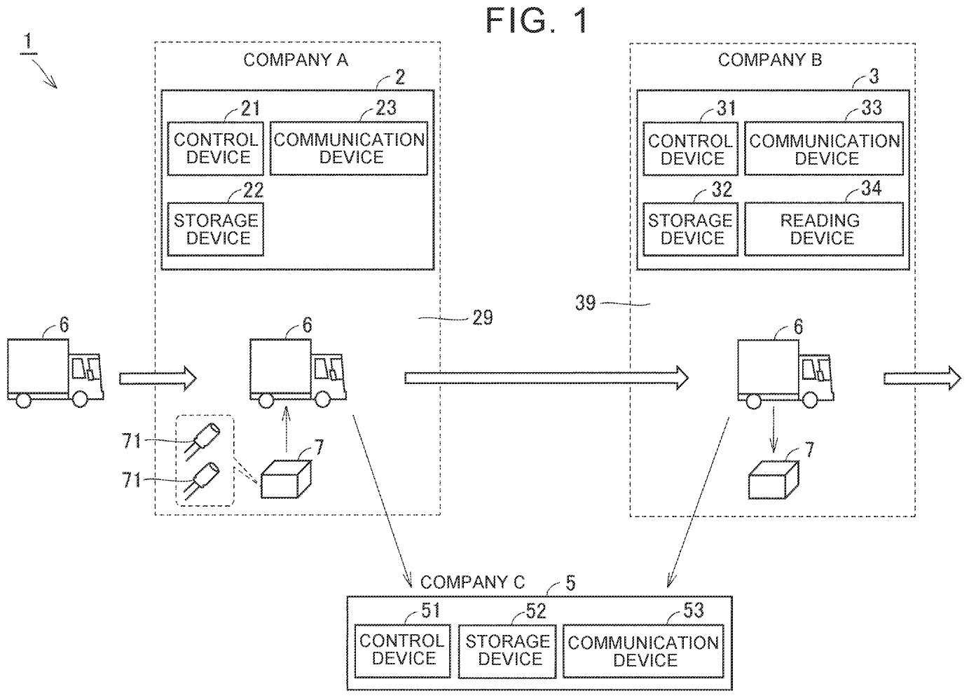

FIG. 1 is an overall configuration diagram of a management system 1 according to the present embodiment. The management system 1 is a system for managing CO2 emissions emitted by production of a product. The management system 1 includes a management device 2 belonging to a company A, a management device 3 belonging to a company B, and a management device 5 belonging to a company C that conducts transportation business using a transport vehicle 6. The company A and the company B constitute a supply chain. The company A is an upstream company of the company B in the supply chain. The company A delivers a product 71 that is a product of the company A to the company B. The product 71 is packed in a packing box 7 and transported from the company A to the company B by the transport vehicle 6. In the present embodiment, the product 71 is an electronic component. Note that the product 71 is not limited to the electronic component, and may be various raw materials. Moreover, the product 71 is not limited to being packed in the packing box 7 and transported, and the product 71 may be loaded into the transport vehicle 6 and transported. The product 71 may be, for example, a component such as an automobile engine and a door.

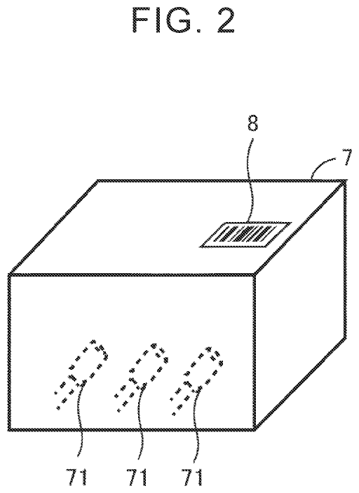

FIG. 2 is a diagram showing an example of the packing box 7. A barcode 8 is attached to the packing box 7. A quick response (QR) code (registered trademark) may be attached to the packing box 7 instead of the barcode 8. Note that, when the product 71 is not packed in the packing box 7, the barcode 8 may be attached directly to the product 71, for example.

With reference to FIG. 1 again, the management device 2 of the company A manages CO2 emissions Q1 emitted by production of the product 71. The CO2 emissions Q1 emitted by the production of the product 71 includes CO2 emissions Q1a required to produce the product 71 using a raw material on a production line of the company A, and CO2 emissions Q1b from production of the raw material. The company A purchases the above raw material from an upstream company (not shown) in the supply chain. The management device 2 calculates the CO2 emissions Q1b based on information (CO2 emissions per unit weight of a raw material) reported by the upstream company that is a supplier of the raw material. The management device 2 calculates the CO2 emissions Q1 by adding the CO2 emissions Q1b to the CO2 emissions Q1a, and manages the CO2 emissions Q1. Note that, in the description below, the CO2 emissions Q1 will also be referred to as “CO2 emissions Q1 in the production process”.

The management device 2 includes a control device 21, a storage device 22, and a communication device 23. The control device 21, the storage device 22, and the communication device 23 are connected to a bus (not shown).

The control device 21 is configured by, for example, an integrated circuit including a central processing unit (CPU). The control device 21 includes a memory and executes various programs stored in the memory. Various programs include an operating system and the like. The memory is configured to include, for example, a read-only memory (ROM) that stores the various programs described above, and a random access memory (RAM) that functions as a working memory and temporarily stores various types of data necessary for executing the various programs.

The storage device 22 stores a first conversion formula (first conversion information) for converting consumed electric energy into the CO2 emissions. The first conversion formula may be, for example, a formula to multiply the consumed electric energy by a first CO2 emission factor. The first CO2 emission factor may be, for example, a value published by a country, government, or a business operator. The first CO2 emission factor may be set for each type of power (whether the power is renewable energy, etc.). The first conversion formula stored in the storage device 22 is updated by the control device 21, for example, when the published first CO2 emission factor is updated.

The communication device 23 is configured to be communicable with the management device 3. Communication between the communication device 23 and the management device 3 is performed via, for example, the Internet. Further, the communication device 23 is configured to be communicable with a management device (not shown) of an upstream company in the supply chain. Communication between the communication device 23 and the management device of the upstream company is performed via, for example, the Internet.

The control device 21 causes the storage device 22 to store, for example, the CO2 emissions per unit weight of the raw material, the CO2 emissions received from the upstream company in the supply chain. For example, the control device 21 calculates the weight of the raw material used per unit number of the products 71 by dividing the weight of the raw material used to produce the lot of the product 71 (on assumption that the product 71 is made of the raw material) by the number of the products 71 included in the lot. The control device 21 calculates the CO2 emissions Q1b emitted by the production of the raw material by multiplying the weight by the CO2 emissions per unit weight of the raw material, and stores the calculated CO2 emissions Qb1 in the storage device 22.

The control device 21 also acquires electric energy consumed in the production line (not shown) for producing the product 71 (consumed electric energy E). The consumed electric energy E in the present embodiment is the electric energy consumed in the production of one lot. The consumed electric energy E may be measured by a power meter (not shown) provided on the production line, or may be measured by the management device 2. The consumed electric energy E may be, for example, power consumed in a factory building in which the production line is installed. The power consumed in the factory building can include power for operating all instruments related to production of the product, such as air conditioning, lighting, component transport vehicles (forklifts, etc.), production line conveyors, impact wrenches, assembly devices, etc. For example, when multiple production lines are installed in the factory building, the power consumed by the production line may include power for operating instruments related to production of the corresponding product produced on the production line, and may not include power for operating instruments related to production of the product produced on another production line.

The control device 21 reads out the conversion formula from the storage device 22. The control device 21 inputs the consumed electric energy E into the conversion formula and calculates CO2 emissions Qcal emitted on the production line in the production of one lot. The control device 21 calculates the CO2 emissions Q1a required to produce the products 71 using the raw material on the production line of the company A by dividing the CO2 emissions Qcal by the number of the products 71 included in one lot.

The control device 21 adds the CO2 emissions Q1a to the CO2 emissions Q1b and calculates the CO2 emissions Q1 in the production process. Specifically, the CO2 emissions Q1 in the production process are represented by the following formula (1).

Q1=Q1a+Q1b (1)

The control device 21 causes the storage device 22 to store the CO2 emissions Q1 in the production process. The control device 21 transmits the CO2 emissions Q1 in the production process to the management device 3 via the communication device 23, as triggered by the delivery of the product 71 to the company B or in response to a request from the company B.

The management device 3 includes a control device 31, a storage device 32, a communication device 33, and a reading device 34. The control device 31, the storage device 32, the communication device 33, and the reading device 34 are connected to a bus (not shown).

The control device 31 is configured by, for example, an integrated circuit including a CPU. The control device 31 includes a memory and executes various programs stored in the memory. Various programs include an operating system and the like. The memory is configured to include, for example, a ROM that stores the various programs described above, and a RAM that functions as a working memory and temporarily stores various types of data necessary for executing the various programs.

The storage device 32 stores the CO2 emissions Q of the product 71 purchased from the company A (upstream company). The CO2 emissions Q are represented by the following formula (2) and include the CO2 emissions Q1 in the production process and the CO2 emissions Q2 in the transportation process.

Q=Q1+Q2 (2)

Although the details of the CO2 emissions Q2 in the transportation process will be described later, the CO2 emissions Q2 in the transportation process are CO2 emissions emitted to transport the product 71 from the company A to the company B. The control device 31 acquires the CO2 emissions Q2 in the transportation process from the management device 5 via the communication device 33.

The communication device 33 is configured to be communicable with the management device 2 and the management device 5. Communication between the communication device 33, and the management device 2 and the management device 5 is performed via, for example, the Internet.

The reading device 34 is configured to be able to read the barcode 8. The reading device 34 includes a barcode reader. As shown in FIG. 2, the barcode 8 is attached to the packing box 7. The reading device 34 acquires product information of the product 71 by reading the barcode 8.

The product information of the product 71 includes the delivery number, the identification number, delivery date and time, information on the supplier company (the company A in the present embodiment), information on the number of the products 71 in the packing box 7, and the like. The control device 31 causes the storage device 32 to store the product information read by the reading device 34.

The control device 31 transmits the delivery number (or the identification number) included in the product information to the management device 2 of the company A via the communication device 33. In the present embodiment, transmission of the delivery number (or the identification number) means a disclosure request for the CO2 emissions Q1 in the production process. As a response to the disclosure request, the control device 31 acquires the CO2 emissions Q1 in the production process from the management device 2 via the communication device 33.

Further, the control device 31 acquires the CO2 emissions Q2 in the transportation process from the management device 5 via the communication device 33. Specifically, the control device 31 acquires the CO2 emissions Q2total emitted by transportation of the packing box 7 from the management device 5, divides the CO2 emissions Q2total by the number of the products 71 in the packing box 7, and calculates the CO2 emissions Q2 in the transportation process. The control device 31 associates the CO2 emissions Q1 in the production process and the CO2 emissions Q2 in the transportation process with the identification number (or the delivery number) of the product 71, and stores the CO2 emissions in the storage device 32 as the CO2 emissions Q of the product 71.

The management device 5 manages the transport vehicles 6. In the present embodiment, the transport vehicle 6 is a vehicle with an internal combustion engine (not shown). In addition, the transport vehicle 6 is equipped with a communication device and a global positioning system (GPS) receiver, both of which are not shown. The communication device may be, for example, a data communication module (DCM). The transport vehicle 6 is configured to be communicable with the management device 5 via a communication device. The transport vehicle 6 is configured to transmit location information, fuel consumption information, and state information to the management device 5 at predetermined intervals. The state information is information indicating whether a running system of the transport vehicle 6 is in an active state or in a sleep state. The fuel consumption information indicates amount of fuel consumed by the transport vehicle 6 during a predetermined cycle. The fuel consumption information may be information on the remaining amount of fuel. The transport vehicle 6 is an example of a “moving object” according to the present disclosure.

The management device 5 includes a control device 51, a storage device 52, and a communication device 53. The control device 51, the storage device 52, and the communication device 53 are connected to a bus (not shown).

The control device 51 is configured by, for example, an integrated circuit including a CPU. The control device 51 includes a memory and executes various programs stored in the memory. Various programs include an operating system and the like. The memory is configured to include, for example, a ROM that stores the various programs described above, and a RAM that functions as a working memory and temporarily stores various types of data necessary for executing the various programs.

The storage device 52 stores various types of information (location information, fuel consumption information, and state information) received from the transport vehicle 6. Further, the storage device 52 stores location information of the company A and location information of the company B. That is, the storage device 52 stores the location information of the transportation source (the company A in the present embodiment) and the transportation destination (the company B in the present embodiment) of a package transported by the transport vehicle 6.

Further, the storage device 52 stores a second conversion formula (second conversion information) for converting the fuel consumption into the CO2 emissions. The second conversion formula may be, for example, a formula to multiply the fuel consumption by a second CO2 emission factor. The second CO2 emission factor may be, for example, a value published by a country, government, or a business operator. The second CO2 emission factor may be set for each type of fuel (gasoline, light oil, biodiesel, etc.), for example. The second conversion formula stored in the storage device 52 is updated by the control device 51, for example, when the published second CO2 emission factor is updated.

The communication device 53 is configured to be communicable with the transport vehicle 6 and the management device 3. Communication between the communication device 53, and the transport vehicle 6 and the management device 3 is performed via, for example, the Internet.

The control device 51 calculates the CO2 emissions Q2total in the transportation process that is the CO2 emissions emitted by the transport vehicle 6 to transport the product 71 (packing box 7) from the company A to the company B. Specifically, the control device 51 converts the fuel consumption of the transport vehicle 6 from a start time point T1 in the transportation process to a completion time point T2 in the transportation process into CO2 emissions using the second conversion formula, and the converted value is taken as the CO2 emissions Q2total in the transportation process. The control device 31 calculates the CO2 emissions Q2 per unit number of the products 71 in the transportation process by dividing the CO2 emissions Q2total by the number of the products 71 in the packing box 7.

The control device 51 determines the start time point T1 and the completion time point T2 based on the location information and the state information received from the transport vehicle 6. The control device 51 determines the time point at which the state information of the transport vehicle 6 is switched from the sleep state to the active state in a site 29 of the company A as the start time point T1. The control device 51 determines the time point at which the state information of the transport vehicle 6 is switched from the active state to the sleep state in a site 39 of the company B as the completion time point T2.

The control device 51 transmits the CO2 emissions Q2total in the transportation process to the management device 3 of the company B via the communication device 53.

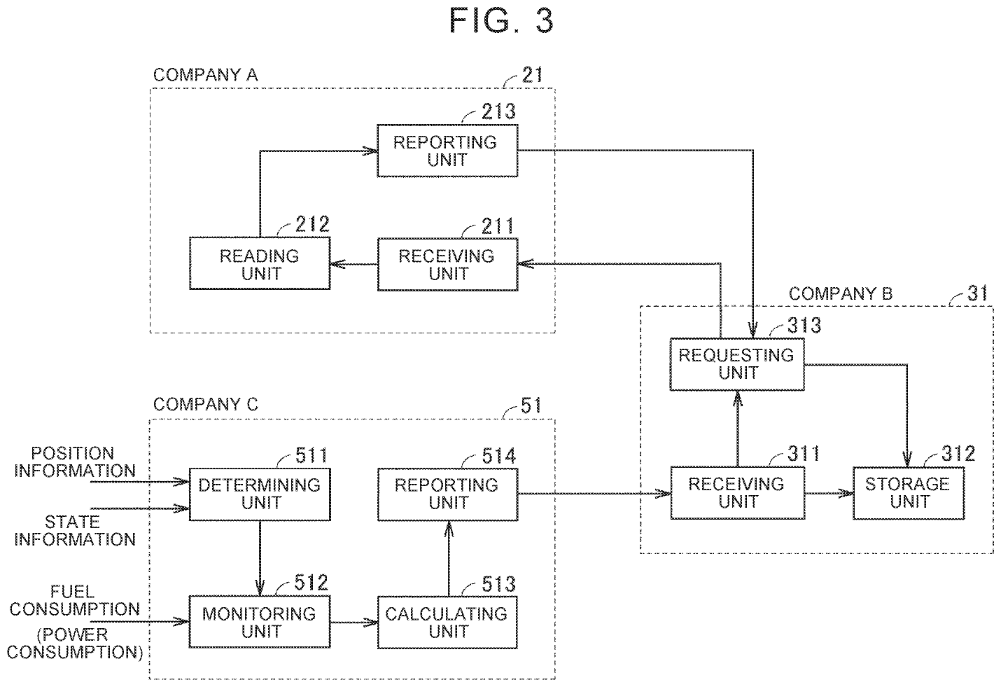

FIG. 3 is a functional block diagram of the control device 21 of the management device 2, the control device 31 of the management device 3, and the control device 51 of the management device 5. The control device 21 includes a receiving unit 211, a reading unit 212, and a reporting unit 213. The control device 31 includes a receiving unit 311, a storage unit 312, and a requesting unit 313. The control device 51 includes a determining unit 511, a monitoring unit 512, a calculating unit 513, and a reporting unit 514. Each of the control devices 21, 31, 51 realizes the function of each unit by executing a program stored in the memory. It should be noted that each of the above units can also be realized by, for example, dedicated hardware (electric circuit).

The determining unit 511 acquires the location information and the state information from the transport vehicle 6 at predetermined intervals, and determines the start time point T1 and the completion time point T2 in the transportation process using the information. The determining unit 511 identifies the location of the transport vehicle 6 based on the location information. The determining unit 511 determines the time point at which the state information of the transport vehicle 6 is switched from the sleep state to the active state in the site 29 of the company A as the start time point T1. The determining unit 511 notifies the monitoring unit 512 that the start time point T1 is determined. The determining unit 511 determines the time point at which the state information of the transport vehicle 6 is switched from the active state to the sleep state in the site 39 of the company B as the completion time point T2. The determining unit 511 notifies the monitoring unit 512 that the completion time point T2 is determined.

The monitoring unit 512 acquires the fuel consumption information from the transport vehicle 6 at predetermined intervals. The monitoring unit 512 outputs, to the calculating unit 513, the fuel consumption information integrated during a period from when the monitoring unit 512 receives the notification that the start time point T1 is determined until the monitoring unit 512 receives the notification that the completion time point T2 is determined from the determining unit 511.

The calculating unit 513 calculates the CO2 emissions Q2total in the transportation process using the fuel consumption information received from the monitoring unit 512 and the second conversion formula. That is, the calculating unit 513 converts the total value of the fuel consumption accumulated from the start time point T1 to the completion time point T2 into the CO2 emissions using the second conversion formula as the CO2 emissions Q2total in the transportation process. The calculating unit 513 outputs the calculated CO2 emissions Q2total in the transportation process to the reporting unit 514.

The reporting unit 514 transmits the CO2 emissions Q2total in the transportation process to the management device 3 of the company B via the communication device 53. Note that the reporting unit 514 transmits the CO2 emissions Q2total in the transportation process to the management device 3 of the company B in association with the information for specifying the product 71 or the packing box 7. The information for specification may be, for example, the delivery number or the identification number assigned to each product 71. The identification number may be assigned on a lot-by-lot basis (that is, the products 71 of the same lot have the same identification number).

The receiving unit 311 receives the CO2 emissions Q2total in the transportation process transmitted from the management device 5 of the company C. The receiving unit 311 outputs the CO2 emissions Q2total in the transportation process to the storage unit 312.

The storage unit 312 calculates the CO2 emissions Q2 in the transportation process per unit number of the products 71 by dividing the CO2 emissions Q2total in the transportation process by the number of the products 71 packed in the packing box 7. Then, the storage unit 312 stores the CO2 emissions Q2 in the transportation process in the storage device 32 in association with the delivery number for specifying the product 71. Note that, when a plurality of the packing boxes is loaded on the transport vehicle 6, for example, the CO2 emissions Q2 in the transportation process per unit number of the products 71 may be calculated after the CO2 emissions Q2total is divided proportionally for each packing box based on the number of packing boxes loaded. Furthermore, the CO2 emissions Q2total may be divided proportionally for each packing box based on the weight ratio of the packing box.

The receiving unit 311 also notifies the requesting unit 313 that the receiving unit 311 receives the CO2 emissions Q2 in the transportation process.

The requesting unit 313 transmits the identification number (or the delivery number) to the management device 2 of the company A via the communication device 33. As a response to the above, the requesting unit 313 acquires the CO2 emissions Q1 in the production process of the product 71 from the management device 2 of the company A via the communication device 33. The requesting unit 313 outputs the CO2 emissions Q1 in the production process to the storage unit 312. Note that, the requesting unit 313 may transmit the identification numbers of all the products 71 in the packing box 7 to the management device 2 of the company A, or may transmit the delivery number to the management device 2 of the company A.

The storage unit 312 associates the CO2 emissions Q1 in the production process with the CO2 emissions Q2 in the transportation process, and stores the CO2 emissions in the storage device 32. The CO2 emissions Q1 in the production process and the CO2 emissions Q2 in the transportation process are stored in the storage device 32 as the CO2 emissions Q of the product 71. The CO2 emissions Q1 in the production process and the CO2 emissions Q2 in the transportation process can be associated with each other using the identification number of the product 71, for example. Note that the method for associating the CO2 emissions Q1 in the production process with the CO2 emissions Q2 in the transportation process is not limited to the above method, and various known methods can be used.

The receiving unit 211 receives the identification number (or the delivery number) transmitted from the management device 3 of the company B. The receiving unit 211 outputs the identification number (or the delivery number) to the reading unit 212.

The reading unit 212 reads the CO2 emissions Q1 in the production process specified by the identification number (or the delivery number) from the storage device 22. The reading unit 212 outputs the read CO2 emissions Q1 in the production process to the reporting unit 213.

The reporting unit 213 transmits the CO2 emissions Q1 in the production process to the management device 3 via the communication device 23. With the above, the CO2 emissions Q1 in the production process of the product to be delivered are reported to the company B.

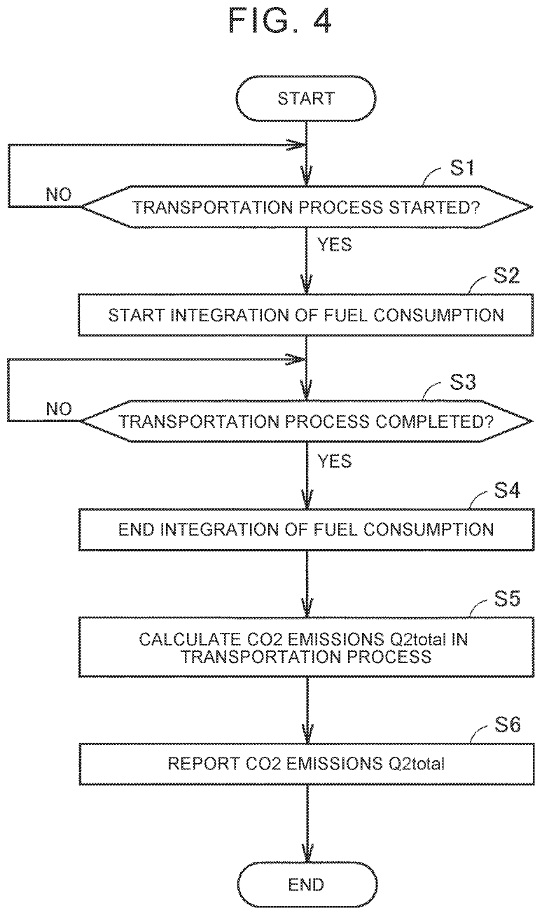

FIG. 4 is a flowchart showing the procedure of processing for reporting the CO2 emissions Q2total in the transportation process. The processing is executed by the control device 51 of the management device 5. The flowchart is started when the transport vehicle 6 is detected to arrive at the site 29 of the company A. A case in which each step (hereinafter step is abbreviated as “S”) of the flowchart shown in FIG. 4 is realized by software processing by the control device 51 will be described. However, a part or all of the steps may be realized by hardware (electronic circuit) fabricated in the control device 51.

In S1, the control device 51 determines whether the transportation process of the product 71 (packing box 7) is started based on the location information and the state information received from the transport vehicle 6. Specifically, the control device 51 determines that the transportation process is started when the transport vehicle 6 is present in the site 29 of the company A and the state information of the transport vehicle 6 is switched from the sleep state to the active state. That is, the control device 51 determines the time point at which the state information of the transport vehicle 6 is switched from the sleep state to the active state in the site 29 of the company A as the start time point T1. When the control device 51 determines that the transportation process is not started (the state information indicates the sleep state (NO in S1)), the control device 51 waits for the transportation process to start. When the control device 51 determines that the transportation process is started (YES in S1), the process proceeds to S2.

In S2, the control device 51 starts integration of the fuel consumption. The control device 51 integrates the fuel consumption from the start time point T1 to the completion time point T2.

In S3, the control device 51 determines whether the transportation process of the product 71 (packing box 7) is completed based on the location information and the state information received from the transport vehicle 6. Specifically, the control device 51 determines that the transportation process is completed when the transport vehicle 6 is present in the site 39 of the company B and the state information of the transport vehicle 6 is switched from the active state to the sleep state. That is, the control device 51 determines the time point at which the state information of the transport vehicle 6 is switched from the active state to the sleep state in the site 39 of the company B as the completion time point T2. When the control device 51 determines that the transportation process is not completed (the state information indicates the active state) (NO in S3), the control device 51 continues integration of the fuel consumption. When the control device 51 determines that the transportation process is completed (YES in S3), the process proceeds to S4.

In S4, the control device 51 ends integration of the fuel consumption. With the above, the fuel consumption from the start time point T1 to the completion time point T2 is integrated.

In S5, the control device 51 reads out the second conversion formula from the storage device 52, and calculates the CO2 emissions Q2total in the transportation process using the integrated fuel consumption and the second conversion formula.

In S6, the control device 51 transmits the CO2 emissions Q2total in the transportation process to the management device 3 of the company B via the communication device 53. With the above, the CO2 emissions Q2total in the transportation process are reported to the company B.

The management device 3 of the company B proportionally divides the reported CO2 emissions Q2total by the number of the products 71 packed in the packing box 7, whereby the CO2 emissions Q2 in the transportation process per unit number of the products 71 can be calculated.

As described above, in the management system 1 according to the present embodiment, the management device 5 that manages the transport vehicle 6 calculates the CO2 emissions Q2total in the transportation process based on the fuel consumption consumed by the transport vehicle 6 to transport the product 71 from the company A to the company B. Since the CO2 emissions Q2total in the transportation process are calculated based on the actual fuel consumption, it is possible to calculate the accurate CO2 emissions.

### First Modification

In the present embodiment, the start time point T1 and the completion time point T2 in the transportation process are determined based on the location information and the state information acquired from the transport vehicle 6. However, the method for determining the start time point T1 and the completion time point T2 is not limited to the above. In the first modification, the start time point T1 and the completion time point T2 in the transportation process are determined based on reading of the barcode for transportation that is attached to the packing box 7.

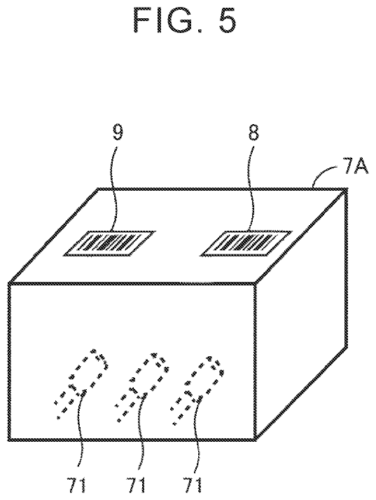

FIG. 5 is a diagram showing an example of a packing box 7A according to the first modification. A barcode 9 for transportation is attached to the packing box 7A in addition to the barcode 8. The transport vehicle 6 is equipped with a terminal device (not shown) associated with the transport vehicle 6. When the driver of the transport vehicle 6 receives the packing box 7A from the company A, the driver selects a receipt button on the terminal device and reads the barcode 9. The terminal device transmits receipt information and barcode reading information to the management device 5 together with the identification number of the terminal device. The driver of the transport vehicle 6 selects a handover button on the terminal device and reads the barcode 9 when the driver hands over the packing box 7A to the company B. The terminal device transmits handover information and the barcode reading information to the management device 5 together with the identification number of the terminal device.

The management device 5 (control device 51) can set the time point at which the receipt information is received as the start time point T1. The management device (the control device 51) can set the time point at which the handover information is received as the completion time point T2. Which delivery item the receipt information belongs to can be determined, for example, based on the barcode reading information. Even in the configuration of the first modification, it is possible to achieve the same effect as the embodiment.

### Second Modification

In the embodiment and the first modification, an example in which the moving object is a vehicle equipped with an internal combustion engine has been described. However, the moving object is not limited to the vehicle equipped with the internal combustion engine. For example, the moving object may be a battery electric vehicle. In this case, the moving object includes a battery and a drive device that is driven using the power of the battery. When the moving object is a battery electric vehicle, the CO2 emissions Q2total in the transportation process can be calculated based on the power consumption of the mobile body from the start time point T1 to the completion time point T2. Further, when the moving object is a hybrid electric vehicle, the CO2 emissions Q2total in the transportation process can be calculated based on the power consumption and the fuel consumption of the mobile body from the start time point T1 to the completion time point T2.

Furthermore, the moving object is not limited to a four-wheeled vehicle, and may be a two-wheeled vehicle. Also, the moving object may be an aircraft, a train, a helicopter, or the like.

### Third Modification

It is also conceivable to form a consortium among the companies included in the management system 1 and share information among the companies using the distributed ledger technology. In this case, the management devices 2, 3, 5 may function as nodes to form a distributed ledger network with nodes of other companies included in the supply chain. For example, the management device 2 (node) transmits to the distributed ledger network the transaction data including information on the CO2 emissions Q1 in the production process to be reported to the company B that is a downstream company. When the management device 3 (node) of the company B approves the transaction data, the CO2 emissions Q1 in the production process are reported to downstream companies. Further, the management device 5 (node) transmits to the distributed ledger network the transaction data including information on the CO2 emissions Q2total in the transportation process to be reported to the company B that is a delivery destination of the product 71. When the management device 3 (node) of the company B approves the transaction data, the CO2 emissions Q2total in the transportation process are reported to downstream companies. Reporting the CO2 emissions using the distributed ledger technology can make information more resistant to tampering.

The embodiment disclosed herein should be considered to be exemplary and not restrictive in all respects. The scope of the present disclosure is shown by the scope of claims rather than the descriptions above, and is intended to include all modifications within the meaning and the scope equivalent to the scope of claims.

What is claimed is:

1. A management device comprising:
a communication device configured to communicate with a moving object configured to transport a product from an upstream company to a downstream company; and
a control device configured to calculate CO2 emissions emitted by transportation of the product based on an amount of energy consumed by the moving object from a transportation start time point to a transportation completion time point of the product.

2. The management device according to claim 1, wherein:
the control device is configured to acquire location information and a state information from the moving object via the communication device;
the transportation start time point is a time point at which the moving object is switched from a sleep state to an active state in a site of the upstream company, and
the transportation completion time point is a time point at which the moving object is switched from the active state to the sleep state in a site of the downstream company.

3. The management device according to claim 1, wherein:
the moving object includes an internal combustion engine; and
the control device is configured to calculate the CO2 emissions based on fuel consumption consumed by the moving object from the transportation start time point to the transportation completion time point.

4. The management device according to claim 1, wherein:
the moving object includes a battery and a drive device configured to be driven using power of the battery; and
the control device is configured to calculate the CO2 emissions based on power consumption consumed by the moving object from the transportation start time point to the transportation completion time point.

5. A management method executed by a management device, the management method comprising:
communicating with a moving object configured to transport a product from an upstream company to a downstream company; and
calculating CO2 emissions emitted by transportation of the product based on an amount of energy consumed by the moving object from a transportation start time point to a transportation completion time point of the product.
